(19) United States
(12) Patent Application Publication
(10) Pub. No.: US 2025/0008893 A1
(43) Pub. Date: Jan. 9, 2025

(54) SYSTEMS, METHODS, AND APPARATUSES FOR IMPLEMENTING TILT MONITORING AND AUTOMATIC SAFETY SHUT-OFF FOR SELF-PROPELLED IRRIGATION TOWERS

(71) Applicant: Rucker Agrisystems LLC, Mulino, OR (US)

(72) Inventors: Jimmy Ivan Rucker, Arlington, OR (US); Jason Patrick Rucker, Mulino, OR (US); Colby Whitaker, Oregon City, OR (US)

(21) Appl. No.: 18/217,965

(22) Filed: Jul. 3, 2023

(51) Int. Cl. A01G 25/16; A01G 25/09; B05B 12/00; B05B 12/08

(52) U.S. Cl. CPC A01G 25/16; A01G 25/092; B05B 12/004; B05B 12/08

(57) ABSTRACT

Systems, methods, and apparatuses for implementing tilt monitoring and automatic safety shut-off for self-propelled irrigation towers. For example, an exemplary system includes a tilt monitor installed upon an irrigation tower, wherein the tilt monitor is to measure a degree of tilt of the irrigation tower away from vertical reference perpendicular to a horizontal ground reference; a drive controller of the irrigation tower having a safety switch integrated therein via which to halt drive wheels of the irrigation tower when the irrigation tower is not operating within a safe condition; an irrigation tower tilt monitoring system installed upon the irrigation tower and communicably interfaced with the tilt monitor, wherein the irrigation tower tilt monitoring system is to iteratively receive tilt angles from the tilt monitor and compare the tilt angles received with pre-configured tilt thresholds stored by the irrigation tower tilt monitoring system to determine whether the irrigation tower is presently operating within a safe condition; an operational halt signal trigged by the irrigation tower tilt monitoring system and transmitted to the drive controller of the irrigation tower when the irrigation tower tilt monitoring system determines the irrigation tower is no longer operating within the safe condition based upon the tilt angles received falling outside of the pre-configured tilt thresholds; and wherein the irrigation tower tilt monitoring system issues the operational halt signal to all irrigation towers affixed to the common irrigation span, causing the entire common irrigation span to cease operation. Other related embodiments are disclosed.

### CLAIM OF PRIORITY

None.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments disclosed herein relate generally to the technical field of agricultural irrigation systems. More particularly, disclosed embodiments relate to systems, methods, and apparatuses for implementing tilt monitoring and automatic safety shut-off for self-propelled irrigation towers.

### BACKGROUND

The subject matter discussed in the background section is not to be considered prior art merely because of its mention in the background section. Similarly, a problem mentioned in the background section or associated with the subject matter of the background section shall not be considered to have been previously recognized in the prior art. The subject matter in the background section merely represents different approaches, which in and of themselves, may also correspond to claimed embodiments.

Common agricultural irrigation systems include center-pivot systems and lateral-movement systems, each having an elevated, elongated irrigation pipe supported by a drive tower supporting the pipe or multiple such drive towers spaced along the pipe to support the irrigation span. The water sprinklers are dispersed along the length of the irrigation pipe, which may optionally extend downward toward crops to facilitate distribution of water to the crops from above.

Center-pivot systems are ideal for use in agricultural fields having circular crop areas and generally include a single water hydrant or water source located in the middle of each circular crop area. With such systems, mechanical spans are linked together radially outward from the hydrant. Each mechanical span includes a tower and a truss assembly that supports an irrigation pipe and water sprinklers to deliver water to the crop area while the spans rotate about the hydrant.

Conversely, lateral-move systems are ideal for use in square, rectangular, and irregularly-shaped fields. Such lateral-move systems generally include one or more hydrants located throughout the agricultural field or may optionally utilize water source hydrants located adjacent to, or at the perimeter of such fields. For instance, irrigation ditches located along or through a field may serve as the water source when connected with the pipe and sprinklers of the lateral-move systems. Unlike the center-pivot system having a pipe with a stationary end, the irrigation pipe in a lateral-move system is connected with, and extends from, a movable cart designed to traverse forwards and backwards along the length of the cart path. Optionally, the irrigation pipe may also be locked at an angle perpendicular to the cart path and pivot at an end of the cart path, which is a desirable implementation when the cart path extends down the middle of a field to enable pivoting from one side of the cart path to the other side with each pass along the cart path.

In both center-pivot and lateral-move irrigation systems, each span extends a significant length. For example, a single span commonly extends between 135-feet to 200-feet. Movement of the span during irrigation operations employ the use of drive towers, each having two or more wheels driven by a mechanical drive unit. The mechanical drive units may be a series of electric motors or other similar sources of propulsion. Generally speaking, the mechanical drive units propel the span forward or backward in a circular or lateral movement pattern along a field and the over crops, so as to provide crop irrigation.

Complicating matters for crop irrigation, however, is the unfortunate reality that agricultural fields are not perfectly flat or smooth or free of obstacles. For instance, farm equipment, vehicles, trees, rocks, and even hills and depressions in the crop-field present obstacles to self-propelled irrigation systems. If sufficient in size, such obstacles can interfere with movement and operation of the irrigation system to such an extent as to not only obstruct the path of the irrigation system, but potentially cause significant damage.

Unfortunately, there is no known system available today which facilitates irrigation system tilt monitoring and safety shut-off in a reliable and inexpensive manner.

The present state of the art may therefore benefit from the systems, methods, and apparatuses for implementing tilt monitoring and automatic safety shut-off for self-propelled irrigation towers, as is described herein.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1A depicts an exemplary irrigation system retrofitted with the irrigation tower tilt monitoring system, in accordance with described embodiments;

FIG. 1B depicts another exemplary irrigation system having multiple irrigation towers, each retrofitted with the irrigation tower tilt monitoring system, in accordance with described embodiments;

FIG. 2A depicts an exemplary irrigation tower having a tilt monitor or tilt sensor integrated thereupon, in accordance with described embodiments;

FIG. 2B depicts another view of the exemplary irrigation tower having a tilt monitor or tilt sensor integrated thereupon, in accordance with described embodiments;

FIG. 2C depicts yet another view of the exemplary irrigation tower having a tilt monitor or tilt sensor integrated thereupon, in accordance with described embodiments;

FIG. 3A depicts another exemplary embodiment of the irrigation tower having the irrigation tower tilt monitoring system depicted in greater detail, in accordance with described embodiments;

FIG. 3B depicts an alternative embodiment for the irrigation tower tilt monitoring system when installed onto an irrigation tower, in accordance with the described embodiments; and

FIG. 4 depicts a high level block diagram and board layout of the irrigation tower tilt monitoring system, in accordance with described embodiments.

### DETAILED DESCRIPTION

Described herein are systems, methods, and apparatuses for implementing tilt monitoring and automatic safety shut-off for self-propelled irrigation towers. For example, there is a system including: a tilt monitor installed upon an irrigation tower, wherein the tilt monitor is to measure a degree of tilt of the irrigation tower away from vertical reference perpendicular to a horizontal ground reference; a drive controller of the irrigation tower having a safety switch integrated therein via which to halt drive wheels of the irrigation tower when the irrigation tower is not operating within a safe condition; an irrigation tower tilt monitoring system installed upon the irrigation tower and communicably interfaced with the tilt monitor, wherein the irrigation tower tilt monitoring system is to iteratively receive tilt angles from the tilt monitor and compare the tilt angles received with pre-configured tilt thresholds stored by the irrigation tower tilt monitoring system to determine whether the irrigation tower is presently operating within a safe condition; an operational halt signal trigged by the irrigation tower tilt monitoring system and transmitted to the drive controller of the irrigation tower when the irrigation tower tilt monitoring system determines the irrigation tower is no longer operating within the safe condition based upon the tilt angles received falling outside of the pre-configured tilt thresholds; and wherein the irrigation tower tilt monitoring system issues the operational halt signal to all irrigation towers affixed to the common irrigation span, causing the entire common irrigation span to cease operation.

In certain embodiments, the irrigation system includes a safety system which monitors for an out of alignment condition (e.g., bending of the irrigation span on a horizontal plane) but lacks capability to monitor, detect, correct, or issue a halt for an excessive tilt condition (e.g., the tilt of an irrigation tower on a vertical plane in which a top portion of the irrigation tower tilts toward or away from the horizontal plane, measured as pitch angle). In such embodiments, the tilt monitor installed upon the irrigation tower monitors for an excessive tilt condition and when detected, the tilt monitor issues a halt through the pre-existing safety system by either tripping a relay to remove power (e.g., where tripping the relay removes power to the pre-existing safety system which is monitored to detect out of alignment condition) and when the relay is tripped, the existing safety system responsively halts the system on the basis of an out of alignment condition being determined, however, the irrigation system need not be out of alignment. Rather, the tilt monitor operates by over-riding or “hijacking” the signal of the existing safety system and mimics conditions of an out of alignment condition when they do not exist, so as to cause the pre-existing safety system to trigger the halt of the irrigation system on behalf of the tilt monitor. Alternative embodiments involve the tilt monitor triggering the halt indirectly by sending an electrical signal to the pre-existing safety system which mimics or is compatible with the pre-existing safety system to be interpreted as either a halt instruction or as an out of alignment signal, responsive to which the pre-existing safety system triggers the halt of the irrigation system.

As discussed above, common irrigation systems include center-pivot systems and lateral-move systems each having an elevated, elongated pipe supported by multiple drive towers spread along the pipe.

However, there is a need for a reliable, fully automated, and inexpensive system via which to retrofit existing agricultural irrigation systems capable of monitoring for, detecting, and preventing excessively tilt, which can result in the irrigation system toppling over, resulting in damage to the irrigation system itself, downtime to irrigation operations, irrigation failures and thus potential damage to crops, as well as a risk of flooding and waste of water resources.

Therefore, described herein is an automated system specially configured for retrofit onto existing irrigation systems and incorporated into newly manufactured irrigation systems which provides for both detection and also prevention of excessive tilt conditions within an operating irrigation system via an automatic shut-off and optional tilt event notification system.

According to described embodiments, the irrigation tower tilt monitor assesses the amount of tilt a tower is out of level and responsively shuts down the irrigation system before any tower connected with the span topples over, thus preventing damage to the irrigation system which would result in the event of toppling.

Unlike presently known systems which measure and control for out of alignment condition along the horizontal plane (e.g., checking for whether the irrigation system is within alignment tolerances along the length of the span), there is no known system available today which monitors, detects, and triggers a safety shutdown for excessive tilt conditions which may lead to toppling of one or more towers.

Present alignment systems are an important innovation as they prevent a portion of the span from advancing too far or falling behind, which could result in excessive pressure along the irrigation pipe, especially at connection joints, which could lead to pipe bursts, flooding or other damage. Similarly, the presently known alignment systems are important as they can accommodate an unexpected obstacle, resulting in one or more towers becoming obstructed and thus, left behind the remaining towers. Effectively, a blocked tower would result in the entire span shutting down as it or the neighboring towers would detect an excessive out of alignment condition.

However, even systems with out of alignment shutdown mechanisms can and often do, topple over entirely, resulting in significant damage and downtime. Such systems may be toppled due to obstacles, but also due to wind gust events or unexpected depressions or excessive hills and high spots in a field. Other operational risks exist, including the failure of existing control and safety systems, deep or muddy tire ruts.

What is needed is an irrigation tower tilt monitoring device capable of retrofit into existing deployments and newly manufactured systems, configurable to stop the tower drive system before it topples over and causes damage to the irrigation system.

The system described herein prevents toppling and tower rollovers by monitoring the tilt of the towers and stopping the drive units on the irrigation towers before a rollover occurs and causes damage. For instance, according to one embodiment, there is a tilt monitoring device in each irrigation tower that detects and stops all the towers if one tower tilts too much, measured as a tilt angle exceeding a pre-determined configurable maximum tilt threshold.

Certain embodiments are designed and specially configured to be incorporated into existing irrigation system deployments by laypersons using simple tools, through a process known as retrofitting. Other embodiments are configured for installation into newly manufactured systems and may be sold to and incorporated by irrigation system manufacturers at a point of manufacture or may be sold to and incorporated by third party resellers and distributors.

Embodiments are designed and specially configured with inexpensive components so as to promote wide adoption and retrofitting of existing systems which not only prevents damage to irrigation systems, but additionally promotes water conservation due to prevention of wasted water resources attributable to toppling events as well as increasing safety for farm workers who risk physical harm due to malfunctioning equipment or repair to damaged equipment.

In the following description, numerous specific details are set forth such as examples of specific configurations, use cases, materials, components, etc., in order to provide a thorough understanding of the various embodiments. It will be apparent, however, to one skilled in the art that these specific details need not be employed to practice the embodiments disclosed herein. In other instances, well-known materials or methods have not been described in detail in order to avoid unnecessarily obscuring the disclosed embodiments.

In addition to various hardware components depicted in the figures and described herein, embodiments further include various operations described below. The operations described in accordance with such embodiments may be performed by specially manufactured components or may utilize general-purpose components in certain instances to realize and perform the innovative function and configuration of the described embodiments. Alternatively, the operations may be performed by a combination of customized specially manufactured components with certain general purpose components to make, use, and practice the inventive aspects as set forth herein.

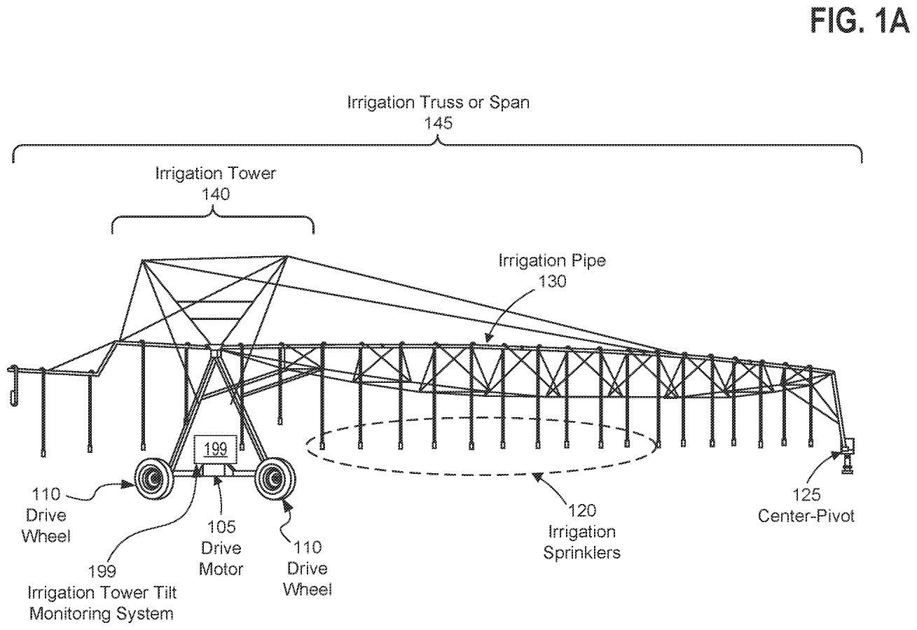

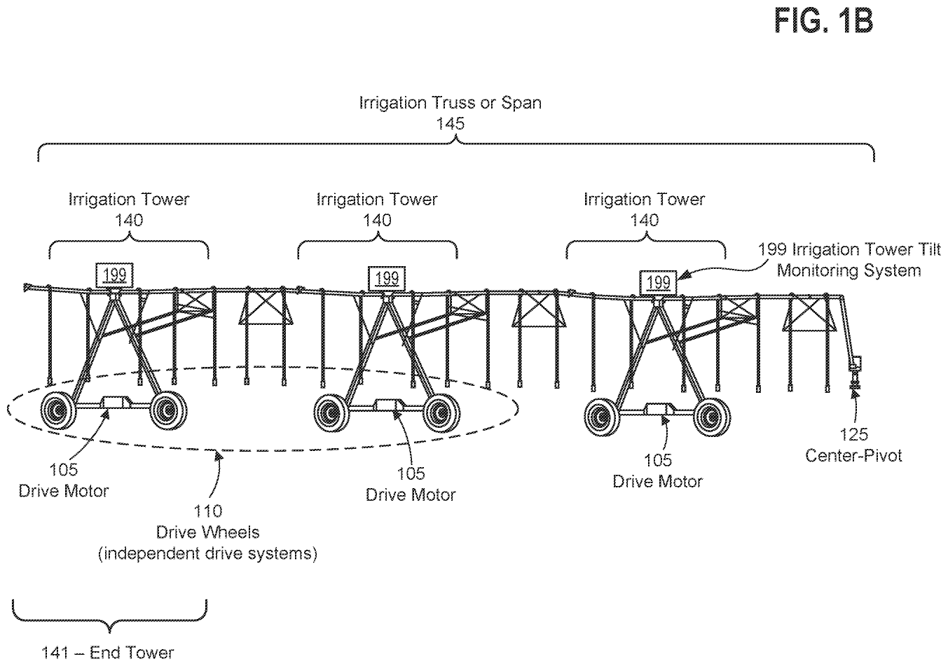

FIG. 1A depicts an exemplary irrigation system retrofitted with the irrigation tower tilt monitoring system 199, in accordance with described embodiments.

As shown here, there is an irrigation tower 140 which is integrated within a larger irrigation truss or irrigation span 145. As depicted, the irrigation tower 140 is connected with a water source via the center-pivot 125 at the right-most side of FIG. 1. The center-pivot 125 typically has a water pump connected with a well, lake, pond, river, irrigation ditch, or some other water source which is pumped into the irrigation system from the center-pivot 125 through the irrigation pipe 130 and down through the irrigation sprinklers 120 where the water is delivered to the crops below. Sometimes the irrigation sprinklers 120 are pointed downward, other times upwards, or in some other configuration depending upon the particular implementation and use of the field within which the crop is grown.

In certain embodiments, the irrigation system (center pivot or lateral movement) alternatively or optionally connected with a water tank or some other supplemental source of water which is configured with a secondary holding tank or other source of agricultural products via which the irrigation system is to inject fertilizers, pesticides or other chemicals with the primary water source for application during irrigation.

Notably, the irrigation tower 140 mechanically supports the irrigation pipe 130 and irrigation sprinklers 120, forming the irrigation truss or span 145 in the manner depicted here.

Positioned locally to the irrigation tower 140 are various components to support the irrigation operations, including drive wheels 110, typically two wheels at each tower, but other configurations are permissible, and a drive motor 105. The irrigation tower 140 depicted here shows a central drive motor which may drive one or both wheels, but other configurations are permissible, such as a drive motor at each wheel.

Additionally depicted is the irrigation tower tilt monitoring system 199, which provides the sensors, logic, functionality, and event triggers via which to monitor for excessive tilt of the irrigation tower 140 away from a horizontal orientation, which may jeopardize the irrigation operations and potentially cause the irrigation tower 140 to tilt over or topple over due to an excessive tilt condition resulting in the irrigation tower 140 surpassing its own center of gravity and thus losing its own balance and footing upon the ground. The concept of toppling over is described in greater detail below, however, fundamentally, an irrigation tower 140 which progresses laterally forward or rearward from its center-line risks moving past its own center of gravity, and thus, will topple over.

Because the irrigation system's irrigation towers 140 are self-propelled, they risk encountering an object or terrain which causes them to walk or drive up the obstacle, thus inducing the risk of toppling over.

FIG. 1B depicts another exemplary irrigation system having multiple irrigation towers 140, each retrofitted with the irrigation tower tilt monitoring system 199, in accordance with described embodiments.

Again depicted is the irrigation truss or span 145, overall supported by the irrigation towers, each having their own drive motors 105, drive wheels 110, and drop irrigation sprinklers supported by the water source originating at the center pivot 125. Notably, each of the irrigation towers 140 shown here include an irrigation tower tilt monitoring system 199, which is now optionally located atop each of the respective towers. The irrigation tower tilt monitoring system 199 may take various shapes and forms and be retrofitted onto the irrigation towers in different places depending upon the particular implementation, irrigation system time, and needs of the operators. For instance, the irrigation tower tilt monitoring system 199 may be co-located with the drive motor, integrated into the drive motor, co-located with an irrigation tower control box, integrated within a pre-existing control box as an in-situ retrofit, or located upon one of the supporting legs of the irrigation tower 140.

The mobile self-propelled irrigation towers 140 and the irrigation truss 145 carry, often along-side the irrigation pipe, inter-connected conduit sections, which provide water or other fluid distribution mechanisms, all directly or indirectly connected with a source of water or fluids from the center pivot. The sprinklers may include spray heads, spray guns, drop nozzles, or other water emitters which are spaced along the conduit sections of the irrigation truss or span 145 to apply water and/or other fluids to land underneath the irrigation system. The irrigation system may also include a central control system for controlling of the electric drive motors 105 which propel the drive wheels 110 to move the mobile support irrigation towers 140 through a crop field.

As shown here, the irrigation system in this embodiment exhibits a much larger truss or span 145, now composed of the three exemplary irrigation towers 140 depicted here, though many more irrigation towers may be present. This irrigation system is again a center-pivot 125 based irrigation system, in which the entire irrigation truss or span 145 rotates around its center pivot 125 making a very large circular configuration, although other types of irrigation systems exist, such as the lateral movement irrigation system in which the entire irrigation truss or span 145 progresses forward and rearward, moving back and forth through a rectangular crop field. The lateral movement irrigation system may also be referred to as a linear movement irrigation system. Odd-shaped fields are also supported through angled-movements of the irrigation truss or span 145 or via an irrigation system which has an intentional angle built into the irrigation truss or span.

Regardless of the system, the type of system, the irrigation tower tilt monitoring system 199 installed at each of the irrigation towers 140 remains equally applicable, as all irrigation towers 140, regardless of the type of system into which they are deployed or the length, size, or shape of the supported irrigation truss or span 145, are ultimately subject to the risk of toppling over, resulting in downtime for the irrigation operations, risk to agricultural works, lost productivity, risk of flooding and waste of water resources, and a near certainty of damaged components of the irrigation system when a toppling event occurs at one or more of the irrigation towers 140.

As shown here, the main section forming the truss or span 145 pivots or rotates about the center pivot 125 and includes various quantities of mobile and self-propelled supporting irrigation towers 140. The outermost irrigation tower shown here is also referred to as an end tower 141, as denoted at the lower left portion of FIG. 1B.

As shown, each of the mobile irrigation towers 140 have wheels 110 driven by drive motors 105, typically through a drive shaft, to move its mobile tower and thus the entirety of the main truss or span 145 in a circle or semicircle about the center pivot 125. The drive motors 105 may include integral or external relays permitting them to be turned on, off, driven forward, driven rearward (e.g., reversed) pursuant to incoming instructions from an irrigation control system. Although not required, some or all of the towers 140 may be equipped with steerable wheels pivoted about upright axes by suitable steering motors so that the towers can follow a pre-determined track (guided virtually or via interaction with guide wires or guide sensors).

According to such embodiments, the drive motors 105 of the irrigation towers 140, in addition to navigation (e.g., circular or forward/rearward movement) are additionally controlled by a safety system which may override the navigational operations of each irrigation tower 140, causing one or more of the irrigation towers 140 to be slowed or completely shut down in the event of the detection of an adverse circumstance. The safety system may also issue instructions to all of the irrigation towers 140 associated with a common span or truss 145, causing the entirety of the irrigation system to halt operation, including movement and delivery of water through the sprinklers.

Notably, there are certain irrigation systems which are optionally configured with swing arm corners, which extend upon both lateral movement and center-pivot system, thus permitting operators to maximize the available space for crops within their fields. Such swing arm corners are helpful to mitigate problems with under watering and overwatering of crop field corners. The systems are highly configurable to permit precision irrigation on different field shapes and terrains. The swing arms are typically controlled via GPS, computers and steerable wheels that are positioned on additional irrigation towers which are deployed beyond what is otherwise the normal end tower, or the last irrigation tower in the span with non-steerable wheels.

Regardless of the configuration, the towers which make up an extended swing arm corner system, are also susceptible to excessive tilting and thus risk toppling over. Therefore, it is in accordance with the disclosed embodiments, that the irrigation tower tilt monitoring system 199 may be installed upon and configured to monitor the tilt angle of such swing arm corner systems and the irrigation towers which make up the swing arm corner systems, so as to monitor for, detect, and mitigate excessive tilting of those irrigation towers, typically by initiating a halt command to that tower and to all irrigation towers within its common irrigation span.

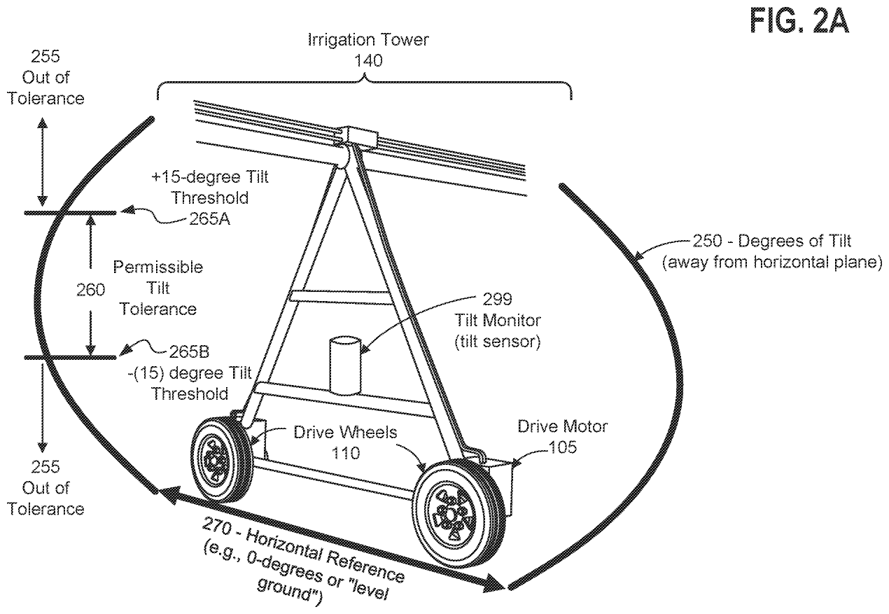

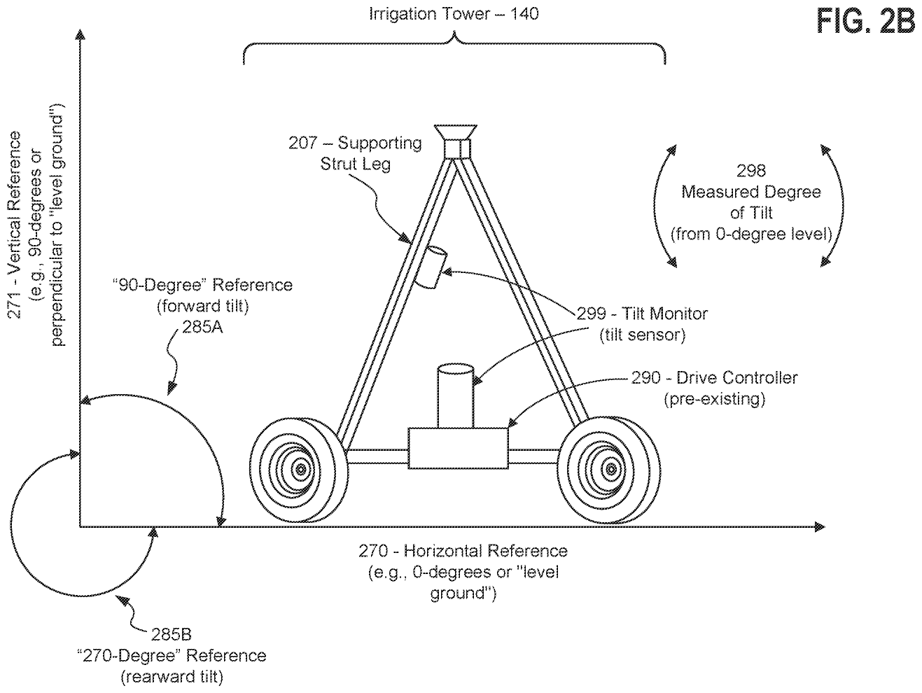

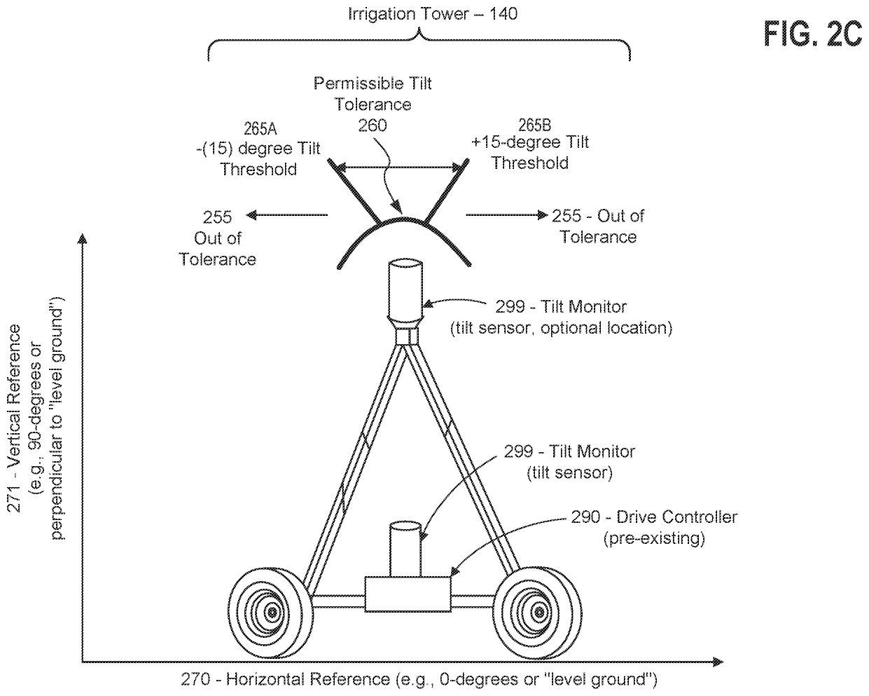

FIG. 2A depicts an exemplary irrigation tower 140 having a tilt monitor 299 or tilt sensor integrated thereupon, in accordance with described embodiments.

As depicted here, the irrigation tower 140 again includes drive wheels 110, and now, separate drive motors 105 each of which are co-located with one of the drive wheels 110. Affixed atop a supporting mid-level strut of the irrigation tower 140 is a tilt monitor 299 or tilt sensor. The tilt monitor 299 may feed into a separate irrigation tower tilt monitoring system 199 (refer back to element 199 at FIGS. 1A and 1B) located elsewhere upon that particular irrigation tower 140, or alternatively, the tilt monitor 299 may be integrated within a common package with the irrigation tower tilt monitoring system 199. Regardless, the tilt monitor 299 is specially configured and provisioned with appropriate sensors via which to monitor, detect, and report as output, a measured degree of tilt. The degree of tilt as utilized herein may be defined in accordance with certain embodiments as the change in angle from perpendicular to the ground. Thus, where there is a horizontal reference representing 0-degrees and thus corresponding to “level ground” upon which the irrigation tower rests, a vertical reference representing 90-degrees and thus exactly perpendicular to the ground (when flat and level) or exactly perpendicular to the horizontal reference would establish a no-tilt condition or 0-degrees of tilt. As the irrigation tower rotates upon its vertical axis laterally forward or rearward which results in one of the drive wheels being higher and one of the drive wheels being lower, a tilt condition is induced upon the irrigation tower, which is measured by the tilt monitor 299 as the measured degrees of tilt.

Specifically depicted here is element 250 at the right-most side of FIG. 2A, depicting the degrees of tilt away from a horizontal plane upon which the irrigation tower 140 is resting or operating.

With reference to the left-most side of FIG. 2A, there are further observed various tolerances which are configurable within the tilt monitor 299 or the irrigation tower tilt monitoring system 199, in accordance with described embodiments.

More specifically, there is a permissible tilt tolerance depicted at element 260 which is configurable by the irrigation system operator, but in this example, is depicted as being a permissible range of tilt tolerance ranging from (−15)-degrees of tilt laterally forward from a vertical 90-degree reference as is represented by element 265A, or +15-degrees of tilt laterally rearward (e.g., minus or negative fifteen-degrees) from a vertical 90-degree reference as is represented by element 265B. This results in a configurable 30-degree range of permissible tilt tolerance 260 within which, the irrigation tower may operate under the monitoring of the tilt sensor 299 without the tilt sensor taking any action whatsoever, other than continuous or iterative monitoring and potentially logging of the measured tilt angles. Notably, however, in this configuration, the tilt monitor 299 or the irrigation tower tilt monitoring system 199 will not alert, alarm, trigger notifications, or most importantly, halt or shut-off operation of the irrigation system as the system will be monitored and measured to be operating within the permissible tilt tolerance 260.

When the irrigation system exceeds the exemplary 15-degrees, plus or minus, measured tilt angle as determined by the tilt monitor 299 (or whatever tilt threshold 265A-B is configured for the irrigation tower's irrigation tower tilt monitoring system 199), then the irrigation tower 140 will be monitored and determined to have exceeded the permissible tilt tolerance 260 by exceeding its tilt thresholds 265A-B, and thus, will be out of tolerance 255 with respect to tilt angle. When this occurs, the irrigation tower tilt monitoring system 199 will automatically and responsively trigger pre-determined excessive tilt event triggers, such as sending or issuing audible alerts and alarms, transmitting to a remote device or monitoring service tilt event alarms, trigger notifications to devices within wireless range of the irrigation systems' irrigation tower tilt monitoring system 199 (e.g., such as notifying an operator in an agricultural vehicle, sending a WiFi or Bluetooth compatible alert to a smart phone, transmitting status to other irrigation tower tilt monitoring systems 199 operating upon the same common irrigation truss or span, or transmitting messages to a remote monitoring service which may then relay the message elsewhere.

Critically, however, regardless of whether or not any notifications or alarms are generated or issued, the irrigation tower tilt monitoring systems 199 at the particular irrigation tower for which the tilt monitor 299 senses the excessive tilt condition (e.g., out of tolerance 255) will automatically and affirmatively cause a system halt instruction and message to be issued to all of the irrigation towers 140 on the common truss or span 145 making up the irrigation system.

To be very clear, regardless of the length or quantity of irrigation towers presently operating for a given truss or span 145 (see FIG. 1B) and regardless of which tower exceeds the permissible tilt tolerance 260 or the monitored tilt condition of the other irrigation towers 140 within the common truss or span 145, the tilt monitor 299 and/or the irrigation tower tilt monitoring systems 199 which observes an excessive tilt condition resulting in the irrigation tower being out of tolerance 255 will cause all irrigation towers on its same irrigation truss or span 145 to immediately cease operation, thus halting the drive motors 105, ceasing movement of the drive wheels, and optionally closing valves on the irrigation pipe so as to terminate all ongoing dispersing of water to the crops below the common truss or span 145, given the halt condition.

The tilt monitor 299 and/or the irrigation tower tilt monitoring systems 199 takes this action (e.g., halting irrigation operations and movement of all irrigation towers for that common irrigation truss or span 145) in one of two primary ways, each of which are described in greater detail below, summarize as issuing an operational out-of-tolerance condition which is reacted to by safety system or revoking an acceptable operational tolerance condition which is monitored by the safety system.

The tilt monitor 299 and/or the irrigation tower tilt monitoring systems 199 as depicted here and as described throughout may similarly be envisioned as providing monitoring capabilities and configurable event triggers for each of pitch, roll, yaw thresholds. Although the irrigation system is operating upon the ground, which is effectively a 2D coordinate grid defined by X and Y axes, such that it can move forward, backwards, and left and right, it nevertheless moves through a 3D space, given that each of the irrigation towers which make up the irrigation system's total span or truss (e.g., see FIG. 1A, element 145). At first glance, this may appear somewhat odd, given that the irrigation system is never intended to move up and down, however, because each irrigation tower has a non-zero and non-trivial height, the reality is that the towers do move through 3D space. In a less technical sense, there are two primary concerns. A first concern for the irrigation tower is the risk of an “out of alignment” condition, fundamentally in which the irrigation span undergoes an excessive amount of bending, creating a pinch-point, while remaining on its horizontal plane. This occurs when one or more of the irrigation towers advance too far in front of others or too far behind others, thus causing the total irrigation span to bend or create an excessive angle, when the irrigation span positioned on the ground is viewed from above. The other concern, and the primary concern addressed by the embodiments disclosed herein, is the risk of an irrigation tower toppling over, in which case, a top portion of an irrigation tower does indeed move through the 3D space, effectively traversing along a “Z” axis, resulting in a top portion of the irrigation tower falling over and ending up lying upon the ground, or at the very least, a top portion of the irrigation tower no longer being fully positioned upright. For example, an irrigation tower may topple over completely or an irrigation tower may partially topple over, but be prevented from fully falling to the ground by the neighboring irrigation towers. In either instance, damage to the irrigation system is nearly certain to have occurred and irrigation operations will be interrupted, potentially resulting in flooding in addition to unwanted downtime.

The irrigation system is subjected to both linear forces due to downward, upward, and side loads as a consequence of both the weight of the system as well as shifting balance of the irrigation system's towers as they traverse a non-uniform ground surface (e.g., bumps, valleys, and obstacles in the path of the irrigation tower's drive wheels). Rotational forces are also incurred, known as moment forces, due to both the non-stationary nature of the total irrigation system being self-propelled by its own drive wheels as well as changes in center of gravity attributable to the orientation of the components of the moving irrigation system and how much water or fluids are present within the irrigation system at any given point in time or the configuration of the sprinklers of the irrigation system. Additionally, as noted above, the individual towers may exceed a tilt threshold, causing them to surpass their center of gravity, and thus, losing balance, resulting in one or more towers undergoing a rotational force about its “Z” axis, in which the irrigation tower or the entire irrigation system consequently topples over.

The rotational forces, defined as roll, pitch, and yaw, describe the respective axis or axes about which a component of the system or the entirety of the system attempts to rotate about.

With conventional nomenclature, consider the three primary axes: X, Y, and Z. The two axes of the horizontal plane (e.g., the ground) are conventionally defined as X and Y, with the X axis being in the direction of motion, such as forward or backward for a lateral movement system or in a sweeping forward or backward arch for a center-pivot irrigation system. Thus, the Y axis is perpendicular or orthogonal to the direction of motion and is also in the horizontal plane. In this example, the Y axis would largely correspond to the span or truss of the irrigation system whereas the X axis corresponds to the direction of travel for the drive wheels of each of the irrigation towers making up the respective irrigation span. Therefore, the remaining Z axis is orthogonal to both the X and Y axes, but representing the vertical plane, and thus, an up and down direction with respect to the ground's horizontal plane.

With these three axes defined, roll, pitch, and yaw may thus be defined with respect to the irrigation system and its respective irrigation towers, as follows:

Roll is a force which causes the system or one of its components to rotate about its X axis, from side-to-side, such as an airplane banking sharply. This force is unlikely to be an issue as each of the irrigation towers are supported by the overall irrigation truss or span. However, individually, an irrigation tower with only two wheels, one fore and one aft, would almost certainly topple over sideways. However, due to being integrated within the irrigation systems truss, this is not an issue. Rather, the concern is the same irrigation tower toppling over in a forward or rearward direction, thus pitching forward or rearward.

Yaw is a force which causes the system or one of its components to rotate about its Z axis. This may be thought of as the entirety of the irrigation system spinning around its vertical or “Z” axis, while remaining perfectly level with the ground. This also is not a primary concern, although can result in an out of alignment condition when a sub-set of the components, such as one of the irrigation towers exhibit excessive yaw, resulting in a portion of the span turning and advancing too far ahead or behind the remaining irrigation towers.

Pitch is a force which causes the system or one of its components to rotate about its Y axis, from front to back, similar to the manner in which an airplane flying straight ahead excessively dives its nose up or down, or a large ship on the ocean cresting a wave and nosing down violently.

It is this pitching force or “tilt” that is of primary concern here, and for which the tilt monitor 299 actively measures, monitors, and then compares with the tilt thresholds to validate whether any given irrigation tower remains within the permissible tilt thresholds configured for that tilt monitor 299 or has exceeded its operational parameters. As stated before, while an out of alignment condition is of concern (e.g., the bending of the span along the horizontal plane) it is this excessive pitching of the irrigation system or its irrigation towers which results in significant damage to the system and agricultural operations when an irrigation tower topples over, as a result of excessive tilt or excessive pitching due to the irrigation tower rotating about its Y axis, and thus, falling out of balance by surpassing its own center of gravity upon which it otherwise remains stable, by having both drive wheels positioned atop the ground. The most obvious situation is for an irrigation tower which advances up too steep of a hill or mound. However, this tends to be less common, and unexpected obstacles such as rocks, vehicles, and farm equipment are more likely culprits, which result in the drive wheels of an irrigation tower advancing up the face of such an obstacle, thus rotating the irrigation tower about its Y axis, resulting in excessive pitch or tilting, and ultimately the irrigation tower or the entire system toppling over.

Thus, the tilt monitor 299 compares the pitch angle with permissible tilt thresholds, but also captures, monitors, and may optionally act upon excessive roll and yaw measurements as well, depending upon the particular implementation.

FIG. 2B depicts another view of the exemplary irrigation tower 140 having a tilt monitor 299 or tilt sensor integrated thereupon, in accordance with described embodiments.

As depicted here, there is now a pre-existing drive controller 290, within which the tilt monitor 299 is retrofitted. Alternatively, the tilt monitor 299 may be retrofitted onto the irrigation tower 140 and a signaling path, wired or wireless, is then configured into the pre-existing drive controller. Certain signaling paths, although less common, are pneumatic or hydraulic, although the function and signaling and tilt detection operations remain the same.

Further depicted in this particular embodiment of the irrigation tower 140 is a different view and vantage point of the horizontal reference at element 270 (e.g., representing 0-degrees or “level ground”) as well as the vertical reference depicted at element 271 corresponding to 90-degrees or an angle perpendicular to “level ground.”

Additional measures are shown, in which element 285A depicts the 90-degrees reference for forward tilt forming a right angle between the horizontal reference at element 270 and the vertical reference at element 271. As depicted in this embodiment, a measured 90-degrees would thus be identical to vertical, resulting in a measured degree of tilt from 0-degree level (see element 298) to be also zero, assuming proper calibration of the tilt monitor 299 and perfectly level ground.

Similarly depicted is a 270-degree reference for rearward tilt at element 285B, via which the tilt monitor 299 may determine not only that the irrigation tower 140 is rotating about its vertical axis, but additionally that the irrigation tower is rotating rearward, or forward, as the case may be.

Because the tilt monitor 299 is able to measure degrees of tilt forward or rearward from zero-degrees level, it is not necessary for the tilt monitor to be installed into any particular location or orientation. Rather a calibration routine may be executed at the time of retrofit, in which an irrigation tower 140 sitting on level ground or generally level ground may then be used to establish the horizontal reference for 0-degrees as shown at element 270. Thus, even if the tilt monitor measures, for example 45-degrees because it has been installed onto a supporting strut leg, as depicted by element 207, then the reference or horizontal may be calculated as zero minus the measured angle, resulting in a horizontal reference which is configured to represent ground level, despite the tilt monitor measuring 45-degrees in this particular example. For instance, the configured horizontal reference would thus be (−315)-degrees or +45-degrees (e.g., minus or negative 315-degrees or positive 45-degrees). The vertical reference at element 271 would thus be configured via a calculated offset of 90-degrees of forward tilt at element 285A or (−270)-degrees offset for the 270-degree reference rearward tilt as depicted at element 285B. Thus, in this particular example, the configured references after calibration for vertical would be +135-degrees for the forward tilt reference at 285A and (−225)-degrees for the “270-degree” reference rearward tilt from vertical as depicted at element 285B. One calibrated, it is irrelevant into what orientation or angle the tilt monitor 299 is physically installed, although, any change to its physical orientation would require re-calibration.

FIG. 2C depicts yet another view of the exemplary irrigation tower 140 having a tilt monitor 299 or tilt sensor integrated thereupon, in accordance with described embodiments.

As shown here, the tilt monitor 299 is now installed atop the upper most point of the irrigation tower 140, although again, the particular location doesn't matter and may be chosen based upon the implementation needs and ease of retrofitting by the operator responsible for the install or retrofit.

Depicted here is again the vertical reference at element 271, a horizontal reference at element 270, the irrigation tower 140 having installed thereupon the pre-existing drive controller 290, the tilt monitor 299 (shown in both an optional location as well as a previously depicted location atop the pre-existing drive controller), and drive wheels and drive motors (not shown here).

Again depicted is the permissible tilt tolerance 260, showing the permissible range of operation when the irrigation tower 140 is under a tilt condition, ranging from the negative 15-degree tilt threshold as depicted at element 265A through the positive 15-degree tilt threshold at element 265B. Outside of the range is out of tolerance as depicted by element 255.

With the configuration shown here, the tilt monitor 299 is configured through electrical, wired, wireless, pneumatic, or hydraulic interface signaling to issue instructions to a safety system which is pre-existing within the drive controller 290. As depicted, the pre-existing drive controller 290 was integrated with the irrigation tower 140 by the manufacturer and provided with the irrigation tower 140 at the time of sale, however, the tilt monitor 299 was not, thus the need for a retrofit. In alternative embodiments, the tilt monitor 299 is manufactured by a third party and sold to the manufacturer of the irrigation system 140 for installation and integration at the time of manufacture, thus negating the need for retrofit. In other embodiments, the tilt monitor 299 is manufactured by a third party and sold to a retailer, distributor, or third party value-added reseller, which integrates the tilt monitor 299 onto the irrigation tower as a purchasable option.

Regardless of when the tilt monitor 299 is integrated with the irrigation tower, it is configured to interface with the drive controller 290 and specifically configured with a signaling path to the safety system of the pre-existing drive controller 290, effectively permitting the tilt monitor 299 to high-jack the operations of the pre-existing drive controller 290, and thus, upon determinable events configurable within the tilt monitor 299, the tilt monitor is able to supersede the functions and determinations of the pre-existing drive controller 290 and cause the drive controller 290 to issue operational halt instructions through the safety system of the pre-existing drive controller 290. In other embodiments, the tilt monitor 299 is retrofitted to issue its own halt instructions to each of the irrigation towers upon a determined halt condition being reached, without having to interact with the pre-existing drive controller 290.

In certain embodiments, accordance of an out of tolerance condition (e.g., a non-safe operational condition) results in the irrigation tower tilt monitoring system 199 automatically and responsively triggering and issuing the operational halt notification and signal. However, in other embodiments, additional validation logic is performed. For instance, the irrigation tower tilt monitoring system 199 may be configured such that a single measured tilt angle out of tolerance results in no action. However, a pre-configured quantity of out of tolerance tilt angles within a pre-configured period of time will result in a halt event. For example, in a crop field with ruts or bumps and thus, uneven terrain, it is conceivable that the irrigation tower may over-tilt momentarily, but remain safe, based on an assessment of the operator. Therefore, so as to avoid false positives, the operator may configure the halt signal to require, for example, five out of tolerance measurements within a 30 second period, as measured every two seconds. This is just an example and other values may be permissibly configured.

In accordance with the described embodiments, a typical safety system consists of a circuit running from a central control system of each irrigation tower's drive controller 290 affixed to each irrigation tower 140 within the span 145. According to such embodiments, a “closed” safety circuit constitutes a safe to proceed condition, effectively providing an acceptable operational tolerance condition, which permits the drive controller to move the drive wheels forward or backwards. Conversely, an open safety circuit results in an electrical circuit which is not complete, and consequently shuts down the irrigation system which requires the safety circuit to be complete and closed, because the open circuit is interpreted as a revocation of acceptable operational tolerance condition which is monitored by the safety system.

Certain safety systems are rudimentary and are literally electrical circuits which must remain closed (e.g., a complete circuit) for the drive controller 290 to be able to operate each respective irrigation tower. If the circuit is opened at any one irrigation tower, then all irrigation towers for the irrigation span cease operation due to literally an electrical fault owing to the open safety circuit.

Other safety systems are more advanced and rely upon microcontrollers which measure conditions digitally or via older analog sensors, and these safety systems will react by halting the irrigation span when any one irrigation tower 140 falls out of tolerance. Most safety systems operate on a fault tolerant fail-safe basis, in which the safety circuit must be closed as a default to operate, and thus, any fault, legitimate or not, terminates operation of the entire irrigation span. Others operate on a subscription or notification basis in which the safety condition is detected and a notification is issued, which is being watched for (e.g., subscription) by all the towers in the span, resulting in the entirety of the irrigation span to cease operation upon a fault condition being reached. Yet other safety systems operation via pneumatics or hydraulics, but again, operate on the principal that a safety switch must remain closed for the drive controllers to be permitted to operate (e.g., air pressure or hydraulic pressure must keep the switch closed in a fail-safe configuration and loss of pressure do to either a fault condition or other problem will cause a fail-safe switch to spring back open, thus terminating operation of the entirety of the irrigation span, regardless of which irrigation tower 140 actually observed the fault).

More modern types of safety systems use antennas and radio communication to send safe or not safe to proceed messages from each irrigation tower 140 to each drive controller 290 or control box to and from a centralized control system for the entire irrigation span or truss 145 (see FIG. 1B).

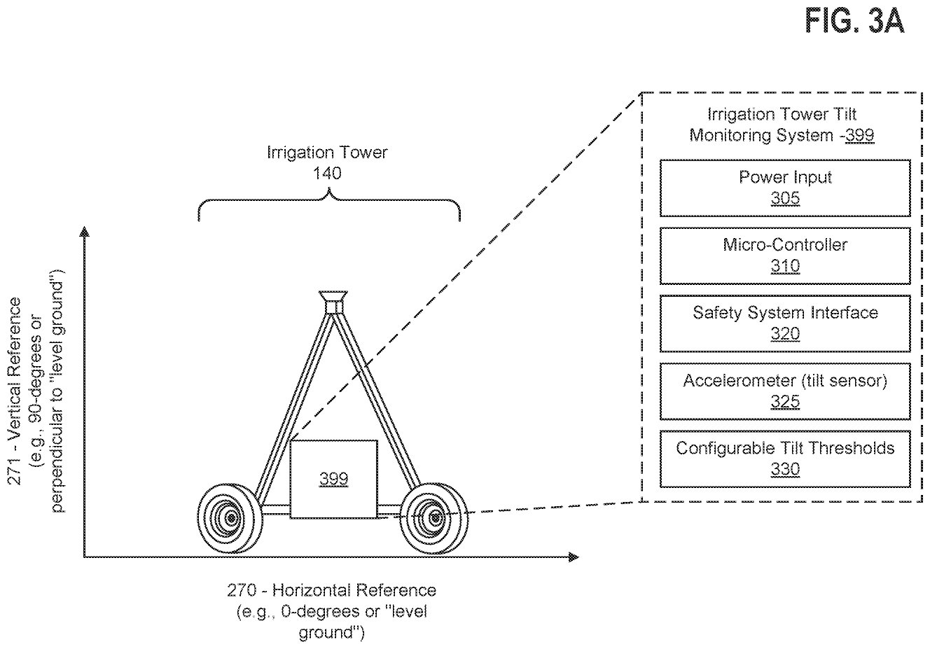

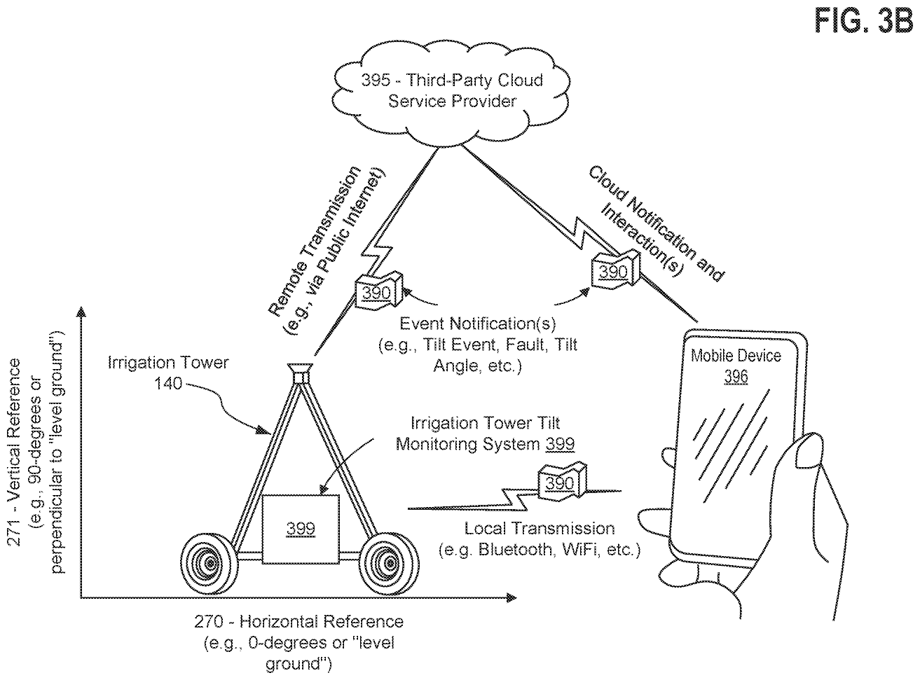

FIG. 3A depicts another exemplary embodiment of the irrigation tower 140 having the irrigation tower tilt monitoring system 399 depicted in greater detail, in accordance with described embodiments.

In particular, there is depicted here, the irrigation tower 140, the vertical reference at element 271, the horizontal reference at element 270, and the irrigation tower tilt monitoring system 399 which has a blow-out of additional sub-components, including the power input 305, the micro-controller 310, the safety system interface 320 (e.g., wired electrically, wireless radio communication interface, pneumatic or hydraulic switched interface, etc.), the accelerometer (e.g., tilt sensor) at element 325, and the configurable tilt thresholds 330 (e.g., stored via simple mechanical dip-switches or stored within NVRAM and configurable via a calibration execution routine at the time of retrofit or re-calibration).

As depicted here, the irrigation tower tilt monitoring system 399 utilizes a micro-controller 310 for issuing instructions, such as an operational halt stopping all drive wheels and optionally stopping water distribution and further includes the accelerometer 325 as a means of measuring tilt angle in comparison with the horizontal and vertical references. The accelerometer monitors change in the angles of tilt of the irrigation tower in which it is installed within the irrigation tower tilt monitoring system 399 or within a tilt monitor of the irrigation tower tilt monitoring system 399. The micro-controller monitors the accelerometer tilt readings to control the safety system by comparing them with configurable thresholds and determining whether or not the measurements of tilt fall within the permissible range of tilt angles. If the accelerometer readings show the tilt angle of the irrigation tower 140 is within acceptable limits, then the safety system permits the irrigation system continue operating by sustaining a safety in its closed position or by broadcasting a safe operational status condition. Conversely, when the accelerometer readings are monitored as being in excess of a threshold, then tilt angle of the irrigation tower 140 is determined as not being within acceptable limits and the safety system is responsively signaled to shut down the irrigation system stopping all drive wheels of all irritation towers on the common irrigation truss or span via wireless signaling, wired electrical signaling, electromechanical signaling (e.g., permitting a relay to spring open) or via pneumatic or hydraulic signaling (e.g., permitting a relay to spring open due to loss of pressure).

FIG. 3B depicts an alternative embodiment for the irrigation tower tilt monitoring system 399 when installed onto an irrigation tower 140, in accordance with the described embodiments.

As shown here, there is again an irrigation tower 140, having retrofitted thereupon the irrigation tower tilt monitoring system 399. The vertical reference 271 and the horizontal reference 270 are again depicted.

Notably, however, there is not a third-party cloud service provider 395 via which the irrigation tower tilt monitoring system 399 may transmit signals, events, instructions, and so forth. As shown here, the irrigation tower tilt monitoring system 399 is issuing a remote transmission 390 from the irrigation tower 140 to the third-party cloud service provider 395 via a public Internet (e.g., wirelessly connected via 3G, 4G, LTE, etc.). The third-party cloud service provider 395 then acts as a relay to communicate cloud notifications and interactions to a mobile device 396. This mobile device may be a monitoring station, a centralized controller for the irrigation span or truss 145, a cell phone or smart phone, a computer system, etc. Regardless, the remote mobile device 396 is configured to receive event notifications from the irrigation tower tilt monitoring system 399, such as tilt events, faults, or even ongoing tilt-angle readings, regardless of whether the tilt angle is operating within or outside of a configured tolerance.

Optionally, the irrigation tower tilt monitoring system 399 may signal to the mobile device via local wireless transmissions, such as Bluetooth or Wifi. For instance, physical electrical connections may be negated entirely by permitting wireless signaling between each irrigation tower tilt monitoring system 399 at each mobile irrigation tower 140, so as to effectuate the signaling of non-permissible operating conditions to the other irrigation towers 140 within a common irrigation span 145 or to a centralized controller for the common irrigation span 145. For example, an excessive tilt angle and system safety halt instructions may be communicated from one irrigation tower 140 to the others or to a centralized controller which then transmits the halt instruction to all the irrigation towers 140 in the common irrigation span 145.

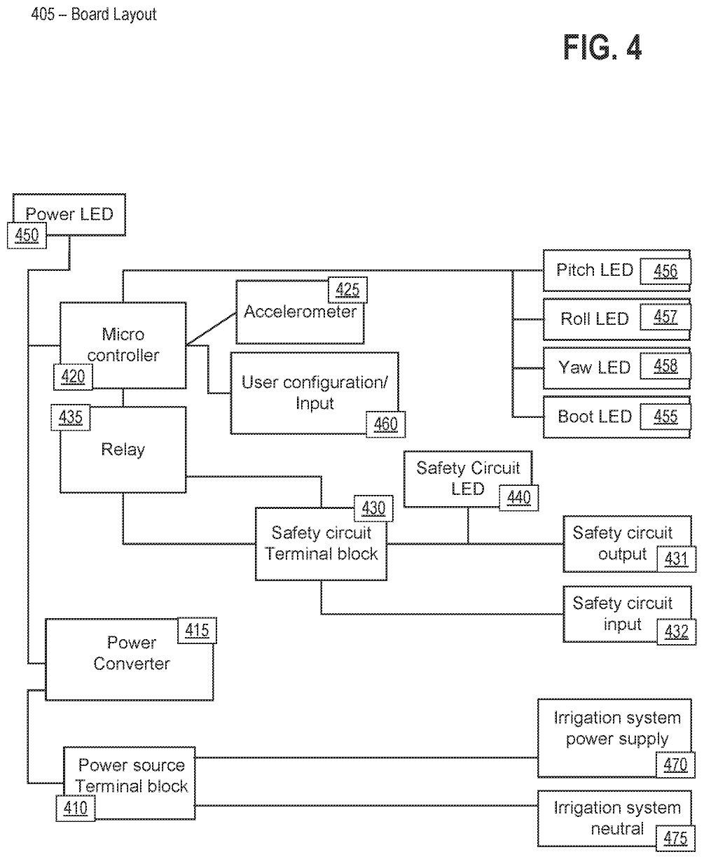

FIG. 4 depicts a high level block diagram and board layout 405 of the irrigation tower tilt monitoring system 399, in accordance with described embodiments.

As shown here, and for this example, the irrigation system power supply is 110-VAC as depicted at element 405. Power enters the board 405 via the power source terminal block 410 and is sent to a power converter 415 to convert to the required power supply for the microcontroller 420 and accelerometer 425. For instance, this may be an AC to DC conversion, or a DC to AC conversion, or may be a simple step up or step down in voltage, depending on the native power utilized by the irrigation system and the power needs of the control board 405 and its components. Note that the power converter 415 is not required if the microcontroller and related hardware is able to run on a common native 110-VAC or some other common voltage amongst the input power and microcontroller 420 and its components.

The irrigation power supply at element 470 (e.g., source power from the irrigation system provided to the board 405) operates separate from the safety circuit. As depicted, the exemplary irrigation system provides elements 470 and 475 which in the block diagram shown here, represent a circuit that constantly supplies power to the board 405. Elements 431 and 432 represent a separate circuit that serves as the safety circuit. As shown here, the safety circuit is 110 VAC, but this is configurable based upon the input voltage supplied by the irrigation system being retrofitted or integrated with the irrigation tower tilt monitoring system 199 (see FIG. 1A). For instance, irrigation systems using some voltage other than 110 VAC will have a safety circuit different than 110 VAC which corresponds to the irrigation system's native power supply. Further still, a pneumatic or hydraulic system may not use an electrical circuit at all, in which case, the safety circuit and its associated components will require a local power source provided via solar and/or battery, for instance, operating at 12-volts. In such embodiments, where the irrigation system is not electrified and thus lacks a source of input power, the status of a hydraulic or pneumatic safety circuit may be measured via a pressure transducer. However, an electrical source would still be utilized to illuminate an LED as well as provide communication means via a Bluetooth or WiFi transponder.

Regardless of whether the safety circuit is opened or closed, power will still be supplied to the board via elements 470/475 or via a separate electrical source, such as a battery or solar.

The PCB's safety circuit terminal block 430 is placed in series in the safety circuit where elements 431 and 432 together represent the safety circuit. A signal enters via the safety circuit input 432 and is routed through the safety circuit terminal block 430, through the relay at element 435, through the safety circuit terminal block 430 and leaves via the safety circuit output 431.

The safety circuit LED element at 440 is independent of the power supply provided by the AC/DC converter (element 415). To be clear, the safety circuit LED 440 is illuminated when the safety circuit is closed, regardless of whether or not the rest of the board 405 has power. As shown here, the safety circuit itself is a 110 VAC power source, and the safety circuit LED 440 is illuminated using that power source. However, if some component on the board 405 fails (e.g., such as the power converter failing as a worst case scenario, resulting in total failure of functionality of the rest of the board) and the safety circuit remains closed (either through the relay being normally closed, or if there were a failure or a short causing the relay to remain closed), then the safety circuit LED 440 will still remain illuminated.

The Power LED at element 450 also operates when the AC/DC converter (and thus the microcontroller) has power from the AC/DC converter 415.

An LED is illuminated when the microcontroller has completed its boot sequence, as depicted by the boot LED at element 455.

The microcontroller 420 polls the values returned by the accelerometer 425, and compares them to the stored user configuration/input values at element 460. When a configured value 460 has been exceeded, the relay 435 is opened, and an LED is illuminated indicating which of the three possible values was exceeded (pitch LED at element 456, roll LED at element 457, or yaw LED at element 458). Notably, where the tilt monitor (e.g., element 299 of FIG. 2A) has an accelerometer mounted at a 45 degree angle or other non-uniform orientation, the tilt monitor may still determine the degree and extent of tilt using the accelerometer by measuring changes to pitch, yaw, and roll. Thus, the accelerometer and tilt monitor may be mounted in literally any position and origination, so long as the calibration routine is performed, thus teaching the tilt monitor its fixed orientation relative to the horizontal and vertical planes (e.g., relative to the ground and relative to vertically up and down).

The safety circuit LED 440 is illuminated when the safety circuit is closed (this is the default state meaning a safe operational condition, as the safety circuit needs to be closed for the irrigation system to run when configured as a fail-safe. The safety circuit LED 440 will turn off when the safety circuit is open. This logic happens regardless of the state of the rest of the PCB's board layout 405. For example, if the relay 435 fails in a closed state, and the microcontroller has told the relay to open the safety circuit terminal block 430, the safety circuit LED 440 will remain on.

For those irrigation system implementation utilizing a pneumatic safety circuit or hydraulic safety circuit, it may be necessary to trigger the non-electrical safety circuit via an electrically actuated pneumatic or hydraulic valve, in addition to an electrical relay. Similarly, an electrical relay may be utilized to provide power to an electrically operated solenoid which operates a non-electrical and instead mechanically actuated pneumatic or hydraulic valve, so as to interrupt the non-electrical pneumatic or hydraulic safety circuit. Thus, regardless of whether the irrigation system utilizes an electrical relay to trigger a system halt, or utilizes a pneumatic or hydraulic valve which is mechanically actuated to trigger the system halt, or utilizes a hybrid system in which a pneumatic or hydraulic valve is mechanically actuated by providing or removing an electrical current, the irrigation tower tilt monitoring system 199 (see FIG. 1A) and/or the tilt monitor 299 (see FIG. 2A) as described herein is able to detect a non-permissible tilt condition of the irrigation towers and responsively trigger a halt of the entirety of the irrigation system via a pre-existing electrical safety circuit, a pre-existing pneumatic safety circuit, a pre-existing hydraulic safety circuit, or a pre-existing hybrid safety circuit, so as to protect the irrigation system and field from further damage.

None of the claims are intended to invoke paragraph six of 35 U.S.C. § 112 unless the exact words “means for” are followed by a participle. While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims are to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A system for implementing tilt monitoring and automatic safety shut-off for one or more self-propelled irrigation towers affixed to a common irrigation span, the system comprising:
a tilt monitor installed upon an irrigation tower, wherein the tilt monitor is to measure a degree of tilt of the irrigation tower away from vertical reference perpendicular to a horizontal ground reference;
a drive controller of the irrigation tower having a safety switch integrated therein via which to halt drive wheels of the irrigation tower when the irrigation tower is not operating within a safe condition;
an irrigation tower tilt monitoring system installed upon the irrigation tower and communicably interfaced with the tilt monitor, wherein the irrigation tower tilt monitoring system is to iteratively receive tilt angles from the tilt monitor and compare the tilt angles received with pre-configured tilt thresholds stored by the irrigation tower tilt monitoring system to determine whether the irrigation tower is presently operating within a safe condition;
an operational halt signal trigged by the irrigation tower tilt monitoring system and transmitted to the drive controller of the irrigation tower when the irrigation tower tilt monitoring system determines the irrigation tower is no longer operating within the safe condition based upon the tilt angles received falling outside of the pre-configured tilt thresholds; and
wherein the irrigation tower tilt monitoring system issues the operational halt signal to all irrigation towers affixed to the common irrigation span, causing the entire common irrigation span to cease operation.

2. The system of claim 1, wherein the irrigation tower tilt monitoring system installed upon the irrigation tower comprises one of:
the irrigation tower tilt monitoring system configured for installation upon the irrigation tower in-situ at a deployed operating location for the irrigation tower;
the irrigation tower tilt monitoring system configured for installation upon the irrigation tower at a manufacturing facility which manufactures the irrigation tower; and
the irrigation tower tilt monitoring system configured for installation upon the irrigation tower at a value added reseller or distributor subsequent to manufacture of the irrigation tower and prior to resale to an end-consumer of the irrigation tower.

3. The system of claim 1, wherein irrigation tower tilt monitoring system issues the operational halt signal further comprises the irrigation tower tilt monitoring system issuing a signal to close a water valve supplying water to the common irrigation span.

4. The system of claim 1, wherein irrigation tower tilt monitoring system issues the operational halt signal further comprises the irrigation tower tilt monitoring system of a first irrigation tower issuing the operational halt signal to at least a second and a third irrigation tower upstream or downstream from the first irrigation tower at which absence of operating within the safe condition was first determined.

5. The system of claim 1:
wherein irrigation tower tilt monitoring system issues the operational halt signal further comprises the irrigation tower tilt monitoring system of first irrigation tower issuing the operational halt signal to a centralized controller;
wherein the centralized controller responsively issues the halt command to all irrigation towers operating as part of the common irrigation forcing the entire common irrigation span to cease operation.

6. The system of claim 1, wherein the irrigation tower tilt monitoring system is to iteratively receive tilt angles from the tilt monitor and compare the tilt angles received with pre-configured tilt thresholds stored by the irrigation tower tilt monitoring system comprises:
the irrigation tower tilt monitoring system to require multiple tilt angles to be received and determined to be outside of the pre-configured tilt thresholds within a pre-configured period of time before the operational halt signal trigged by the irrigation tower tilt monitoring system.

7. The system of claim 1, wherein the operational halt signal trigged by the irrigation tower tilt monitoring system and transmitted to the drive controller of the irrigation tower comprises:
irrigation tower tilt monitoring system cutting power to an electrical relay held closed within the safety switch of the drive controller of the irrigation tower; and
wherein the drive controller cannot operate a drive motor or drive wheels of the irrigation tower when the electrical relay of the safety switch is in an open condition due to loss of power.

8. The system of claim 1, wherein self-propelled irrigation towers affixed to the common irrigation span comprise one of:
a center-pivot irrigation system;
a lateral movement irrigation system; or
a linear movement irrigation system.

9. The system of claim 1, wherein the irrigation tower tilt monitoring system is further configured to:
transmit a signal to a third-party cloud service provider via a public internet network interface; and
wherein the third-party cloud service provider receives and re-transmits the signal to a mobile device authenticated with and subscribed to the third-party cloud service provider.

10. The system of claim 1, wherein the signal comprises one of:
a notification of a safety event resulting in the operational halt signal trigged by the irrigation tower tilt monitoring system;
a log of iteratively received tilt angles;
a status of operational condition.

11. A method for implementing tilt monitoring and automatic safety shut-off for one or more self-propelled irrigation towers affixed to a common irrigation span, the system comprising:
iteratively measuring and outputting, via a tilt monitor installed upon an irrigation tower, a degree of tilt of the irrigation tower away from vertical reference perpendicular to a horizontal ground reference;
communicably interfacing with a drive controller of the irrigation tower having a safety switch integrated therein via which to halt drive wheels of the irrigation tower when the irrigation tower is not operating within a safe condition;
executing monitoring instructions at an irrigation tower tilt monitoring system installed upon the irrigation tower and communicably interfaced with the tilt monitor, wherein the irrigation tower tilt monitoring system iteratively receives as input, tilt angles generated as output from the tilt monitor and wherein the irrigation tower tilt monitoring system further compares the tilt angles received with pre-configured tilt thresholds stored by the irrigation tower tilt monitoring system to determine whether the irrigation tower is presently operating within a safe condition;
triggering an operational halt signal from the irrigation tower tilt monitoring system and transmitting the operational halt signal from the irrigation tower tilt monitoring system to the drive controller of the irrigation tower when the irrigation tower tilt monitoring system determines the irrigation tower is no longer operating within the safe condition based upon the tilt angles received falling outside of the pre-configured tilt thresholds; and
issuing, from the irrigation tower tilt monitoring system, the operational halt signal to all irrigation towers affixed to the common irrigation span, causing the entire common irrigation span to cease operation.

12. The method of claim 11, wherein irrigation tower tilt monitoring system issues the operational halt signal further comprises the irrigation tower tilt monitoring system issuing a signal to close a water valve supplying water to the common irrigation span.

13. The method of claim 11, wherein irrigation tower tilt monitoring system issues the operational halt signal further comprises the irrigation tower tilt monitoring system of a first irrigation tower issuing the operational halt signal to at least a second and a third irrigation tower upstream or downstream from the first irrigation tower at which absence of operating within the safe condition was first determined.

14. The method of claim 11:
wherein irrigation tower tilt monitoring system issues the operational halt signal further comprises the irrigation tower tilt monitoring system of first irrigation tower issuing the operational halt signal to a centralized controller;
wherein the centralized controller responsively issues the halt command to all irrigation towers operating as part of the common irrigation forcing the entire common irrigation span to cease operation.

15. The method of claim 11, wherein the irrigation tower tilt monitoring system is to iteratively receive tilt angles from the tilt monitor and compare the tilt angles received with pre-configured tilt thresholds stored by the irrigation tower tilt monitoring system comprises:
the irrigation tower tilt monitoring system to require multiple tilt angles to be received and determined to be outside of the pre-configured tilt thresholds within a pre-configured period of time before the operational halt signal trigged by the irrigation tower tilt monitoring system.

16. The method of claim 11, wherein the operational halt signal trigged by the irrigation tower tilt monitoring system and transmitted to the drive controller of the irrigation tower comprises:
irrigation tower tilt monitoring system cutting power to an electrical relay held closed within the safety switch of the drive controller of the irrigation tower; and
wherein the drive controller cannot operate a drive motor or drive wheels of the irrigation tower when the electrical relay of the safety switch is in an open condition due to loss of power.

17. The method of claim 11, wherein self-propelled irrigation towers affixed to the common irrigation span comprise one of:
a center-pivot irrigation system;
a lateral movement irrigation system; or
a linear movement irrigation system.

18. The method of claim 11, wherein the irrigation tower tilt monitoring system is further configured to:
transmit a signal to a third-party cloud service provider via a public internet network interface; and
wherein the third-party cloud service provider receives and re-transmits the signal to a mobile device authenticated with and subscribed to the third-party cloud service provider.

19. The method of claim 11, wherein the signal comprises one of:
a notification of a safety event resulting in the operational halt signal trigged by the irrigation tower tilt monitoring system;
a log of iteratively received tilt angles;
a status of operational condition.

20. Non-transitory computer readable storage media having instructions stored thereupon that, when executed by a system having at least a processor and a memory therein, the instructions cause the processor to execute instructions for implementing tilt monitoring and automatic safety shut-off for one or more self-propelled irrigation towers affixed to a common irrigation span, by performing the following operations:
iteratively measuring and outputting, via a tilt monitor installed upon an irrigation tower, a degree of tilt of the irrigation tower away from vertical reference perpendicular to a horizontal ground reference;
communicably interfacing with a drive controller of the irrigation tower having a safety switch integrated therein via which to halt drive wheels of the irrigation tower when the irrigation tower is not operating within a safe condition;
executing monitoring instructions at an irrigation tower tilt monitoring system installed upon the irrigation tower and communicably interfaced with the tilt monitor, wherein the irrigation tower tilt monitoring system iteratively receives as input, tilt angles generated as output from the tilt monitor and wherein the irrigation tower tilt monitoring system further compares the tilt angles received with pre-configured tilt thresholds stored by the irrigation tower tilt monitoring system to determine whether the irrigation tower is presently operating within a safe condition;
triggering an operational halt signal from the irrigation tower tilt monitoring system and transmitting the operational halt signal from the irrigation tower tilt monitoring system to the drive controller of the irrigation tower when the irrigation tower tilt monitoring system determines the irrigation tower is no longer operating within the safe condition based upon the tilt angles received falling outside of the pre-configured tilt thresholds; and
issuing, from the irrigation tower tilt monitoring system, the operational halt signal to all irrigation towers affixed to the common irrigation span, causing the entire common irrigation span to cease operation.
